(19) United States
(12) Patent Application Publication
(10) Pub. No.: US 2026/0125093 A1
(43) Pub. Date: May 7, 2026

(54) TRANSPORT DEVICE AND ROTATABLE OBJECT APPARATUS THEREOF

(71) Applicant: QISDA CORPORATION, Taoyuan City (TW)

(72) Inventor: Kai-Yi Wang, Taoyuan City (TW)

(73) Assignee: QISDA CORPORATION, Taoyuan City (TW)

(21) Appl. No.: 19/290,395

(22) Filed: Aug. 5, 2025

(30) Foreign Application Priority Data
Nov. 1, 2024 (CN) 202411549501.5

(51) Int. Cl. B62B 3/04; B62B 3/10

(52) U.S. Cl. CPC B62B 3/04; B62B 3/108; B62B 2202/56; B62B 2203/60

(57) ABSTRACT

A transport device for transporting an object with long and short axes includes a movable platform, a rod extending from the movable platform and having a longitudinal slot, a plate detachably connected to the object, a pivot component movably disposed along the longitudinal slot and fixed to the plate, an operating component fixed to the pivot component and forming first and second abutting portions, and a support base. The support base is detachably disposed at a side of the rod and has a first support end portion, a concave slot portion, a convex rail portion, and a second support end portion in sequential connection. When the first abutting portion pivots and slides upwardly via the pivot component relative to the longitudinal slot for rotating the plate to an upright position, the second abutting portion slides along the convex rail portion to be supported within the concave slot portion.

### BACKGROUND OF THE INVENTION

### 1. Field of the Invention

The present invention relates to a transport device and a rotatable object apparatus thereof, and more specifically, to a transport device moving and rotating an object on a support base (or a supporting base) to a horizontal position or an upright position and a rotatable object apparatus thereof.

### 2. Description of the Prior Art

In general, transporting a large object with long and short axes, such as a large display screen, involves detachably mounting the large object onto a transport device equipped with a rod (e.g., using screws to secure the object to the rod) and then pushing the transport device for delivering the large object to the destination. However, during the aforesaid transport process, if the large object needs to be rotated to an upright position for passing through a narrow and long door (e.g., an elevator door), rotating the large object may cause much inconvenience. This can result in a time-consuming and strenuous transport process, and improper operation during rotation of the large object may lead to collisions and damage to the large object or even injuries to people.

### SUMMARY OF THE INVENTION

Thus, one purpose of the present invention is to provide a transport device utilizing an operating component to operably pivot and slide relative to a rod for rotating an object to a horizontal position or an upright position with movement of the operating component on a support base (or a supporting base) and a rotatable object apparatus thereof, so as to solve the aforesaid problem.

According to an embodiment, the present invention provides a transport device applied to transportation of an object. The object has a long axis and a short axis. The transport device includes a movable platform, a rod, a plate, a pivot component, and an operating component, and a support base. The rod extends from the movable platform and has a longitudinal slot. The plate is connected to the object. The pivot component is disposed through the longitudinal slot and connected to the plate, to make the plate movable between a first position and a second position with rotation of the pivot component. The operating component is connected to the pivot component. A first abutting portion and a second abutting portion are formed on two ends of the operating component. The support base is disposed at a side of the rod and has a concave slot portion and a convex rail portion. The convex rail portion is connected to the concave slot portion. When the first abutting portion pivots and moves upwardly via the pivot component relative to the longitudinal slot for rotating the plate to the second position, the second abutting portion slides into the concave slot portion along the convex rail portion.

Preferably, the first position is a horizontal position, and the second position is an upright position; the operating component operably moves together with the pivot component and the pivot component moves together with the plate, so that the plate can be rotated to the horizontal position together with the operating component and the pivot component to make the short axis of the object parallel to the longitudinal slot, or rotated to the upright position to make the long axis of the object parallel to the longitudinal slot.

Preferably, the first position is a horizontal position, and the second position is an upright position; the support base further has a first support end portion and a second support end portion, the convex rail portion is connected to the second support end portion, the concave slot portion is connected to the first support end portion, and the first support end portion and the second support end portion support the first abutting portion and the second abutting portion respectively when the plate is located at the horizontal position; the concave slot portion is laterally concave from the first support end portion, and the convex rail portion is laterally convex from the second support end portion, so that a height of a corner of the object closest to the movable platform is greater than or equal to a height of the movable platform when the second abutting portion slides to a top end of the convex rail portion along the convex rail portion.

Preferably, the first abutting portion is bent to form a handle, and/or the second abutting portion is a sliding wheel for sliding to abut against the concave slot portion or the second support end portion along the convex rail portion with rotation and movement of the first abutting portion.

Preferably, the rod has a plurality of segmented slot structures, the support base extends toward the rod to form a protruding piece, and the protruding piece is secured to one of the plurality of segmented slot structures in a screw locking manner for fixing a mounting height of the support base relative to the movable platform.

Preferably, the mounting height is greater than or equal to one-quarter of a length of the object along the long axis of the object.

Preferably, the pivot component includes a slider and a shaft, the slider is slidably disposed in the longitudinal slot, and the shaft rotatably passes through the slider and is fixed to the plate.

Preferably, the object is supported on or above the movable platform when the second abutting portion abuts against the concave slot portion, and/or an extension direction from the second abutting portion to the pivot component is substantially parallel to the longitudinal slot when the second abutting portion abuts against the concave slot portion.

Preferably, the movable platform includes a platform body and a roller. The roller is disposed under the platform body.

According to another embodiment, the present invention further provides a rotatable object apparatus including an object and a transport device. The object has a long axis and a short axis. The transport device carries an object and includes a movable platform, a rod, a plate, a pivot component, an operating component, and a support base. The rod extends from the movable platform and has a longitudinal slot. The plate is detachably connected to the object. The pivot component is slidably and rotatably disposed through the longitudinal slot and fixed to the plate, to make the plate movable between a horizontal position and an upright position with rotation of the pivot component. The operating component is fixed to the pivot component. A first abutting portion and a second abutting portion are formed on two ends of the operating component. The support base is detachably disposed at a side of the rod and has a first support end portion, a second support end portion, a concave slot portion and a convex rail portion. The convex rail portion is connected to the second support end portion and the concave slot portion, and the concave slot portion is connected to the first support end portion. When the first abutting portion pivots and moves upwardly via the pivot component relative to the longitudinal slot for rotating the plate to the upright position, the second abutting portion slides along the convex rail portion to be supported within the concave slot portion.

In summary, compared with the prior art mounting the large object on the rod of the transport device detachably (e.g., by screws), the present invention adopts the rotatable object design in which the operating component can operably pivot and slide relative to the rod along the support base to rotate the object to the horizontal position or the upright position. In such a manner, the user can quickly and effortlessly rotate the object to the horizontal or upright sate according to actual transport conditions. Thus, the present invention can effectively solve the prior art problem that difficulties in rotating the large object cause a time-consuming and strenuous transport process and lead to collisions and damage to the large object or even injuries to people, thereby greatly improving the operating convenience and transportation safety of the transport device during object transportation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a rotatable object apparatus according to an embodiment of the present invention.

FIG. 2 is a partially-enlarged diagram of a transport device in FIG. 1.

FIG. 3 is a diagram of the rotatable object apparatus in FIG. 1 when a second abutting portion slides to a top end P of a convex rail portion along a convex rail portion.

FIG. 4 is a diagram of the rotatable object apparatus in FIG. 3 when a plate rotates to an upright position together with a pivot component.

### DETAILED DESCRIPTION

In order to provide a further understanding of purposes, structures, features, and functions of the present invention, the following detailed description is given in conjunction with embodiments.

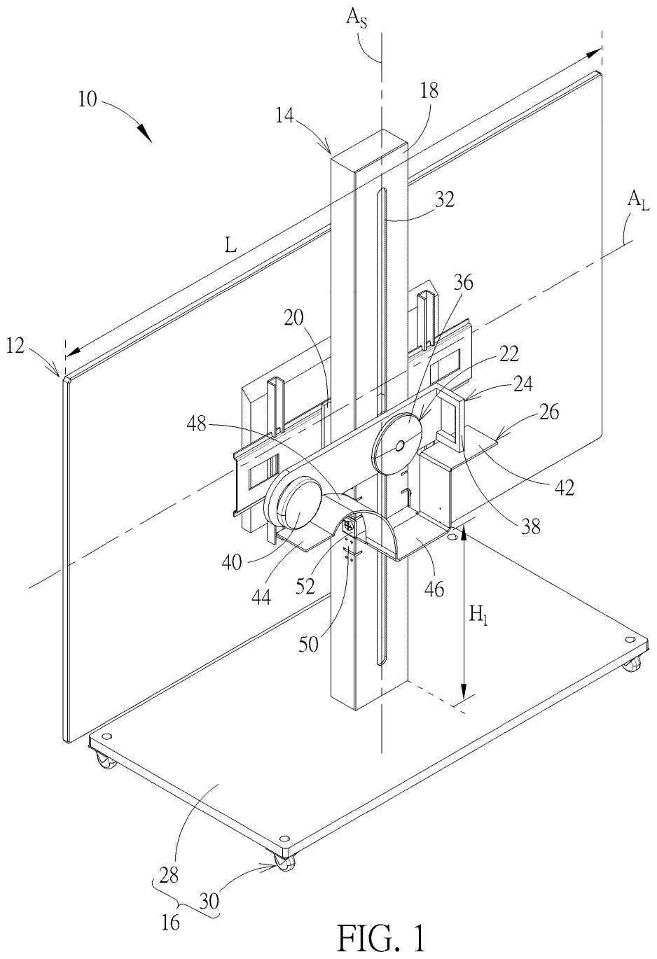

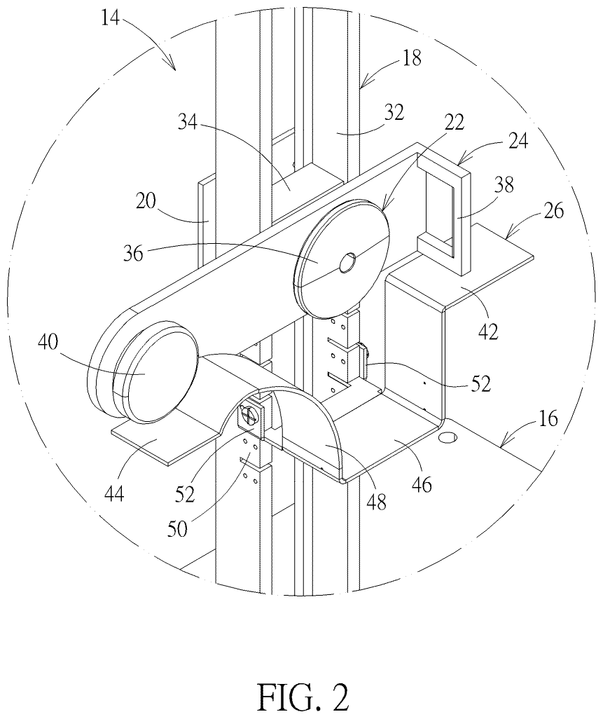

Please refer to FIG. 1 and FIG. 2. FIG. 1 is a diagram of a rotatable object apparatus 10 according to an embodiment of the present invention. FIG. 2 is a partially-enlarged diagram of a transport device 14 in FIG. 1. For clearly showing a sliding structural design between a pivot component 22 and a rod 18, a front cover plate of the rod 18 is omitted in FIG. 2. The rotatable object apparatus 10 is suitable for providing an object rotating function during a transport process of an object 12 having a long axis AL and a short axis AS (in this embodiment, a large-sized display screen (e.g., an 85˜100-inch LCD screen) is used as an example for detailed description, but is not limited thereto), so that the object 12 carried by the transport device 14 can smoothly pass through a narrow and long door (e.g., an elevator door) without collisions or damage.

As shown in FIGS. 1 and 2, the rotatable object apparatus 10 includes the object 12 and the transport device 14. The transport device 14 carries the object 12 and includes a movable platform 16, the rod 18, a plate 20, the pivot component 22, an operating component 24, and a support base (or a supporting base) 26. The movable platform 16 could preferably adopt a roller platform design (but not limited thereto, meaning the present invention could adopt other transport platform designs, such as a tracked platform or an air-cushion platform) for transporting objects. For example, the movable platform 16 could include a platform body 28 and a plurality of rollers 30 (but not limited thereto). The rollers 30 are disposed under the platform body 28 to allow a user to drive the rotatable object apparatus 10 to perform forward, backward, and turning movements. The rod 18 could extend vertically from the platform body 28 and have a longitudinal slot 32. The plate 20 is detachably connected to the object 12 (e.g., by screws or structural engagement). The pivot component 22 is slidably and rotatably disposed in the longitudinal slot 32 and fixed to the plate 20, thereby enabling the plate 20 with the object 12 to move synchronously with the pivot component 22 along the longitudinal slot 32 of the rod 18. More specifically, in this embodiment, the pivot component 22 could include a slider 34 and a shaft 36 (but not limited thereto, meaning that the present invention could adopt other sildable and rotatable structural designs, such as gear-and-rack mechanisms). The slider 34 is slidably disposed within the longitudinal slot 32, and the shaft 36 rotatably passes through the slider 34 and is fixed to the plate 20. As such, the plate 20 with the object 12 can rotate to a horizontal position or an upright position together with the pivot component 22, thereby allowing the user to rotate the object 12 into a horizontal state or an upright state according to the actual transport requirements.

As shown in FIGS. 1 and 2, the operating component 24 is fixed to the pivot component 22 to be operable and move synchronously with the pivot component 22. A first abutting portion 38 and a second abutting portion 40 are formed at two ends of the operating component 24, respectively. The support base 26 is disposed on one side of the rod 18 and has a first support end portion 42, a concave slot portion 46, a convex rail portion 48, and a second support end portion 44 in sequential connection. The first abutting portion 38 could be preferably bent to form a handle (but not limited thereto, meaning that the present invention could adopt other abutting designs, such as a protruding pillar design) and could abut against the first support end portion 42 for the user to grip and operate. The second abutting portion 40 could be preferably a sliding wheel (but not limited thereto, meaning that the present invention could adopt other sliding designs, such as a protruding pillar design) and could abut against the second support end portion 44, so as to make the second abutting portion 40 slide into the concave slot portion 46 along the convex rail portion 48 more smoothly. Preferably, the support base 26 could be detachably disposed at a side of the rod 18.

In practical applications, as shown in FIGS. 1 and 2, the rod 18 could have a plurality of segmented slot structures 50. The support base 26 extends toward the rod 18 to form at least one protruding piece 52 (two protruding pieces 52 connected to both sides of the rod 18 as shown in FIG. 2, but not limited thereto). The protruding piece 52 could be selectively secured to one of the segmented slot structures 50 by screws, allowing the user to appropriately adjust a mounting height H1 of the support base 26 relative to the movable platform 16 according to the actual transport needs. The mounting height H1 could be preferably greater than or equal to one-quarter of a length L of the object 12 along the long axis AL of the object 12 (as shown in FIG. 1), so as to ensure that the object 12 does not collide with the movable platform 16 during the rotation process relative to the rod 18. In one embodiment, the support base 26 could extend toward the rod 18 to further form an insertion piece (e.g., an horizontal sheet adjacent to the protruding piece 52 as shown in FIG. 2), and the protruding piece 52 could be bent from the insertion piece (but not limited thereto). As such, the insertion sheet could be inserted into one of the plurality of segmented slot structures 50 to enhance the structural strength and the support force of the support base 26.

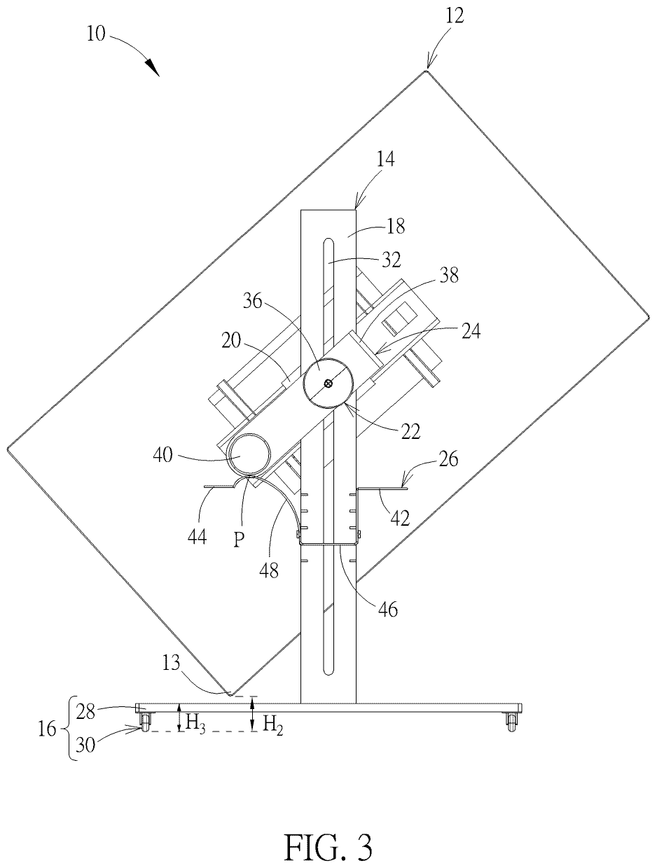

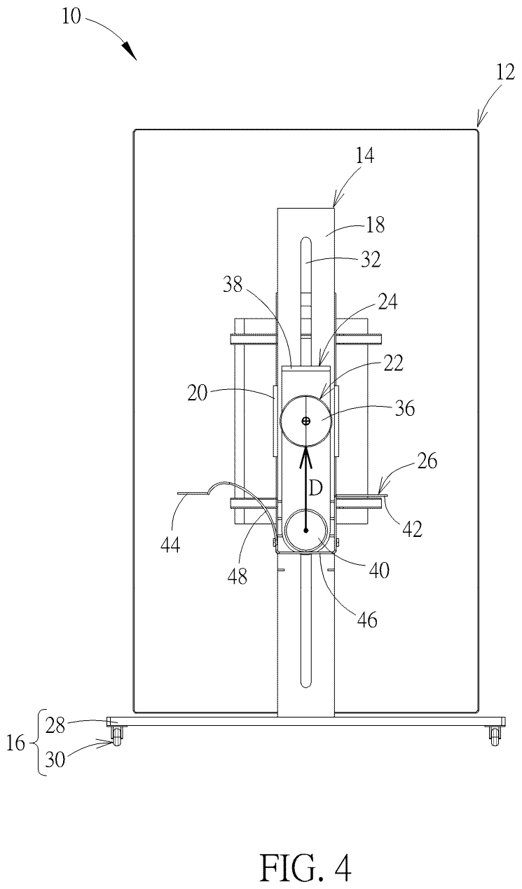

More detailed description for an object rotation operation of the rotatable object apparatus 10 is provided as follows. Please refer to FIGS. 1, 3, and 4. FIG. 3 is a diagram of the rotatable object apparatus 10 in FIG. 1 when the second abutting portion 40 slides to a top end P of the convex rail portion 48 along the convex rail portion 48. FIG. 4 is a diagram of the rotatable object apparatus 10 in FIG. 3 when the plate 20 rotates to the upright position together with the pivot component 22.

Via the aforesaid design, the user can apply force to drive the rotatable object apparatus 10 to transport the object 12. At this time, as shown in FIG. 1, the first support end portion 42 and the second support end portion 44 respectively support the first abutting portion 38 and the second abutting portion 40 when the plate 20 is located at the horizontal position (preferably with the short axis AS of the object 12 parallel to the longitudinal slot 32, but not limited thereto). This maintains the object 12 in the horizontal state steadily, thereby allowing the user to use the transport device 14 to smoothly transport the object 12 to the destination. During this process, if it is necessary to rotate the object 12 to the upright state to pass through a narrow and long door (e.g., an elevator door), the user just needs to grip and then pivot the first abutting portion 38 upward to rotate the plate 20 to the upright position as shown in FIG. 4 (preferably with the long axis AL of the object 12 parallel to the longitudinal slot 32, but not limited thereto). In one embodiment, with rotation and sliding of the pivot component 22, the second abutting portion 40 can slide from a position supported on the second support end portion 44 as shown in FIG. 1 to a position supported within the concave slot portion 46 as shown in FIG. 4 along the convex rail portion 48. As such, the object 12 can be placed in the upright state steadily and smoothly pass through the narrow and long door.

As shown in FIG. 3, the concave slot portion 46 could be laterally concave from the first support end portion 42, and the convex rail portion 48 could be laterally convex from the second support end portion 44 (preferably in a convex curve shape, but not limited thereto, meaning that the present invention could adopt other convex rail designs, such as a convex triangle design). In such a manner, when the second abutting portion 40 slides along the convex rail portion 48 to the top end P of the convex rail portion 48, a height H2 of a corner 13 of the object 12 closest to the movable platform 16 could be preferably greater than or equal to a height H3 of the movable platform 16, so as to ensure that collisions and damage to the object 12 during rotation can be effectively avoided. Furthermore, in practical applications, as shown in FIG. 4, when the second abutting portion 40 is supported within the concave slot portion 46, the object 12 could be suspended above the movable platform 28 to avoid collisions (but not limited thereto, meaning that the present invention could also adopt a design in which the object 12 rests on the movable platform 28 to make the object 12 in the upright state carried on the transport device 14 more steadily. To be more specific, as shown in FIG. 4, when the second abutting portion 40 is supported within the concave slot portion 46, an extension direction D from the second abutting portion 40 to the pivot component 22 could be preferably parallel to the longitudinal slot 32, so as to prevent the object 12 from tilting and becoming unstable due to the shift of the center of gravity of the object 12. Moreover, a width of the concave slot portion 46 could match a size of the second support portion 40 to form a non-vertical abutment for maintaining the object 12 in the upright state. In other embodiments, the concave slot portion 46 could have a portion (e.g., a curved surface) that matches a shape of the second support portion 40 to maintain the object 12 in the upright state.

In summary, compared with the prior art mounting the large object on the rod of the transport device detachably (e.g., by screws), the present invention adopts the rotatable object design in which the operating component can operably pivot and slide relative to the rod along the support base to rotate the object to the horizontal position or the upright position. In such a manner, the user can quickly and effortlessly rotate the object to the horizontal or upright sate according to actual transport conditions. Thus, the present invention can effectively solve the prior art problem that difficulties in rotating the large object cause a time-consuming and strenuous transport process and lead to collisions and damage to the large object or even injuries to people, thereby greatly improving the operating convenience and transportation safety of the transport device during object transportation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transport device applied to transportation of an object, the object having a long axis and a short axis, the transport device comprising:
a movable platform;
a rod extending from the movable platform and having a longitudinal slot;
a plate connected to the object;
a pivot component disposed through the longitudinal slot and connected to the plate, to make the plate movable between a first position and a second position with rotation of the pivot component;
an operating component connected to the pivot component, a first abutting portion and a second abutting portion being formed on two ends of the operating component; and
a support base disposed at a side of the rod and having a concave slot portion and a convex rail portion, the convex rail portion being connected to the concave slot portion;
when the first abutting portion pivots and moves upwardly via the pivot component relative to the longitudinal slot for rotating the plate to the second position, the second abutting portion slides into the concave slot portion along the convex rail portion.

2. The transport device of claim 1, wherein the first position is a horizontal position, and the second position is an upright position; the operating component operably moves together with the pivot component and the pivot component moves together with the plate, so that the plate can be rotated to the horizontal position together with the operating component and the pivot component to make the short axis of the object parallel to the longitudinal slot, or rotated to the upright position to make the long axis of the object parallel to the longitudinal slot.

3. The transport device of claim 1, wherein the first position is a horizontal position, and the second position is an upright position; the support base further has a first support end portion and a second support end portion, the convex rail portion is connected to the second support end portion, the concave slot portion is connected to the first support end portion, and the first support end portion and the second support end portion support the first abutting portion and the second abutting portion respectively when the plate is located at the horizontal position; the concave slot portion is laterally concave from the first support end portion, and the convex rail portion is laterally convex from the second support end portion, so that a height of a corner of the object closest to the movable platform is greater than or equal to a height of the movable platform when the second abutting portion slides to a top end of the convex rail portion along the convex rail portion.

4. The transport device of claim 1, wherein the first abutting portion is bent to form a handle, and/or the second abutting portion is a sliding wheel for sliding to abut against the concave slot portion or the second support end portion along the convex rail portion with rotation and movement of the first abutting portion.

5. The transport device of claim 1, wherein the rod has a plurality of segmented slot structures, the support base extends toward the rod to form a protruding piece, and the protruding piece is secured to one of the plurality of segmented slot structures in a screw locking manner for fixing a mounting height of the support base relative to the movable platform.

6. The transport device of claim 5, wherein the mounting height is greater than or equal to one-quarter of a length of the object along the long axis of the object.

7. The transport device of claim 1, wherein the pivot component comprises a slider and a shaft, the slider is slidably disposed in the longitudinal slot, and the shaft rotatably passes through the slider and is fixed to the plate.

8. The transport device of claim 1, wherein the object is supported on or above the movable platform when the second abutting portion abuts against the concave slot portion, and/or an extension direction from the second abutting portion to the pivot component is substantially parallel to the longitudinal slot when the second abutting portion abuts against the concave slot portion.

9. The transport device of claim 1, wherein the movable platform comprises:
a platform body; and
a roller disposed under the platform body.

10. A rotatable object apparatus comprising:
an object having a long axis and a short axis; and
a transport device carrying an object, the transport device comprising:
a movable platform;
a rod extending from the movable platform and having a longitudinal slot;
a plate detachably connected to the object;
a pivot component slidably and rotatably disposed through the longitudinal slot and fixed to the plate, to make the plate movable between a horizontal position and an upright position with rotation of the pivot component;
an operating component fixed to the pivot component, a first abutting portion and a second abutting portion being formed on two ends of the operating component; and
a support base detachably disposed at a side of the rod and having a first support end portion, a second support end portion, a concave slot portion and a convex rail portion, the convex rail portion being connected to the second support end portion and the concave slot portion, and the concave slot portion being connected to the first support end portion;
wherein when the first abutting portion pivots and moves upwardly via the pivot component relative to the longitudinal slot for rotating the plate to the upright position, the second abutting portion slides along the convex rail portion to be supported within the concave slot portion.

11. The rotatable object apparatus of claim 10, wherein the operating component operably moves together with the pivot component and the pivot component moves together with the plate, so that the plate can be rotated to the horizontal position together with the operating component and the pivot component to make the short axis of the object parallel to the longitudinal slot, or rotated to the upright position to make the long axis of the object parallel to the longitudinal slot.

12. The rotatable object apparatus of claim 10, wherein the first support end portion and the second support end portion support the first abutting portion and the second abutting portion respectively when the plate is located at the horizontal position; the concave slot portion is laterally concave from the first support end portion, and the convex rail portion is laterally convex from the second support end portion, so that a height of a corner of the object closest to the movable platform is greater than or equal to a height of the movable platform when the second abutting portion slides to a top end of the convex rail portion along the convex rail portion.

13. The rotatable object apparatus of claim 10, wherein the first abutting portion is bent to form a handle, and/or the second abutting portion is a sliding wheel for sliding to abut against the concave slot portion or the second support end portion along the convex rail portion with rotation and movement of the first abutting portion.

14. The rotatable object apparatus of claim 10, wherein the rod has a plurality of segmented slot structures, the support base extends toward the rod to form a protruding piece, and the protruding piece is secured to one of the plurality of segmented slot structures in a screw locking manner for fixing a mounting height of the support base relative to the movable platform.

15. The rotatable object apparatus of claim 14, wherein the mounting height is greater than or equal to one-quarter of a length of the object along the long axis of the object.

16. The rotatable object apparatus of claim 10, wherein the pivot component comprises a slider and a shaft, the slider is slidably disposed in the longitudinal slot, and the shaft rotatably passes through the slider and is fixed to the plate.

17. The rotatable object apparatus of claim 10, wherein the object is supported on or above the movable platform when the second abutting portion abuts against the concave slot portion, and/or an extension direction from the second abutting portion to the pivot component is substantially parallel to the longitudinal slot when the second abutting portion abuts against the concave slot portion.

18. The rotatable object apparatus of claim 10, wherein the movable platform comprises:
a platform body; and
a roller disposed under the platform body.
